(19) United States
(12) Patent Application Publication
(10) Pub. No.: US 2009/0068515 A1
(43) Pub. Date: Mar. 12, 2009

(54) Fuel Supplying and Controlling Method and Fuel Cell Apparatus Using the Same

(75) Inventors: CHARN-YING CHEN, Taoyuan County (TW); CHUN-LUNG CHANG, Taoyuan County (TW); DER-HSING LIOU, Taoyuan County (TW); CHIH-LIN HUANG, Taoyuan County (TW); RUI-XIANG WANG, Taoyuan County (TW); SUN-MEI LIN, Taoyuan County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Institute of Nuclear Energy Research Atomic Energy Council, Executive Yuan, Taoyuan County (TW)

(21) Appl. No.: 12/166,524

(22) Filed: Jul. 2, 2008

(30) Foreign Application Priority Data
Sep. 11, 2007 (TW) 096133798

(51) Int. Cl. H01M 8/04

(52) U.S. Cl. 429/23; 429/22

(57) ABSTRACT

A fuel supplying and controlling method and a fuel cell apparatus are provided in the present invention, in which a fuel sensor-less control method and a fuel concentration sensor are combined together to stabilize the operation of the fuel cell apparatus. In one embodiment of the present invention, an optimum range of fuel concentration is determined using the fuel sensor-less control method and then whether the fuel cell apparatus operates within the optimum range of fuel concentration or not is monitored using the fuel concentration sensor as a first line of defense, while the fuel sensor-less control method is used as a secondary line of defense for monitoring. In another embodiment of the present invention, the fuel sensor-less control method is used as a first line of defense for monitoring whether the fuel cell apparatus operates within the optimum range of fuel concentration or not and determining an optimum range of fuel concentration, while whether the fuel concentration exceeds the optimum range of fuel concentration is monitored using the fuel concentration sensor as a second line of defense for monitoring the fuel concentration.

### BACKGROUND OF THE INVENTION

1. Field of the Invention

The present invention generally relates to a fuel supplying and controlling method and a fuel cell apparatus using the same and, more particularly, to a fuel supplying and controlling method and a fuel cell apparatus using the fuel supplying and controlling method, in which a fuel sensor-less control method and a fuel concentration sensor are combined together to stabilize the operation of the fuel cell apparatus.

2. Description of the Prior Art

A fuel cell is a power generating device that uses electro-chemical reactions to transform chemical energy into electrical energy. In a fuel cell, fuel comprising hydrogen and an oxidant (such as the air or oxygen) are introduced respectively to the anode and the cathode of the cell. At the anode, oxidation takes place to ionize the fuel into hydrogen ions and electrons. The hydrogen ions travel from the anode through a proton exchange membrane (PEM) to the cathode to combine with the electrons traveling through the external load circuit to the cathode to cause reduction reaction with oxygen to produce water. Accordingly, as long as the fuel is kept supplied, the fuel cell is capable of generating power continuously with high efficiency and low pollution.

Among currently available fuel cells, the direct methanol fuel cell (DMFC) is widely used as a power supply in various portable electronic appliances such as notebooks, personal digital assistants (PDA's) and global positioning systems (GPS's). The DMFC is advantageous over other fuel cells such as the proton exchange membrane fuel cell (PEMFC) in that liquid-phase methanol is used as fuel to significantly improve security and safety in storage and transportation of fuel.

However, in the supply of fuel for the DMFC, which is well known to those with ordinary skills in the art, the methanol fuel concentration is a key factor. Over-supply of fuel (such as methanol) leads to serious fuel (methanol) crossover, which results from direct reaction between methanol and oxygen to cause a mixed potential at the cathode, to lower the cell performance and even worse, to damage the fuel cell due to a negative voltage. Moreover, the control of the supply of fuel is important to meet the requirement of the load of the fuel cell.

Therefore, there is demand in providing a fuel supplying and controlling method and a fuel cell apparatus using the fuel supplying and controlling method to overcome the aforementioned problems.

### SUMMARY OF THE INVENTION

It is an object of the present invention to provide a fuel supplying and controlling method and a fuel cell apparatus using the method, in which a fuel sensor-less control method is used to control the fuel concentration in fuel cell apparatus, and a fuel concentration range is pre-determined so that whether the fuel concentration exceeds the fuel concentration range is monitored using the fuel concentration sensor as a second line of defense.

It is another object of the present invention to provide a fuel supplying and controlling method and a fuel cell apparatus using the method, in which the fuel sensor-less control method is used as a first line of defense for monitoring whether the fuel cell apparatus operates within the optimum range of fuel concentration or not and determining an optimum range of fuel concentration, while whether the fuel concentration exceeds the optimum range of fuel concentration is monitored using the fuel concentration sensor as a second line of defense for monitoring the fuel concentration.

In one embodiment, the present invention provides a fuel supplying and controlling method, comprising steps of: determining an operation concentration range of a fuel cell module; and using a fuel concentration sensor with a monitoring process to monitor a fuel concentration in the fuel cell module according to the operation concentration range to determine the timing for fuel injection. The operation of the fuel cell module is controlled using a fuel sensor-less control method to replace the abnormal or damaged fuel concentration sensor when the characteristic value for the fuel cell module is abnormal.

In another embodiment, the present invention further provides a fuel supplying and controlling method, comprising steps of; determining an operation concentration range of a fuel cell module; using a fuel sensor-less control method to control the operation of the fuel cell module within the operation concentration range to supply power to a load; and using a fuel concentration sensor with a monitoring process to monitor a fuel concentration in the fuel cell module according to the operation concentration range to determine the timing for fuel injection.

In still another embodiment, the present invention further provides a fuel cell apparatus, comprising: a fuel cell module, being coupled to a load to provide the load with power required for operation; a fuel supplying unit, being coupled to the fuel cell module to provide the fuel cell module with fuel; a fuel concentration sensor, being coupled to the fuel cell module to detect a fuel concentration in the fuel cell module to generate a detection signal; and a measurement control unit, being coupled to the fuel cell module, the fuel supplying unit and the fuel concentration sensor to determine an operation concentration range of the fuel cell module and to determine the timing for fuel injection according to the detection signal.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram of a fuel cell apparatus with a load according to a first embodiment of the present invention;

FIG. 2 is a flowchart of a fuel supplying and controlling method according to a first embodiment of the present invention;

FIG. 3A is a flowchart of determining an operation concentration range according to a first embodiment of the present invention;

FIG. 3B is a flowchart of determining an operation concentration range according to a second embodiment of the present invention; and

FIG. 4 is a flowchart of a fuel supplying and controlling method according to a second embodiment of the present invention.

### DETAILED DESCRIPTION OF THE PREFERRED EMBODIMENT

The present invention can be exemplified but not limited by the preferred embodiment as described hereinafter.

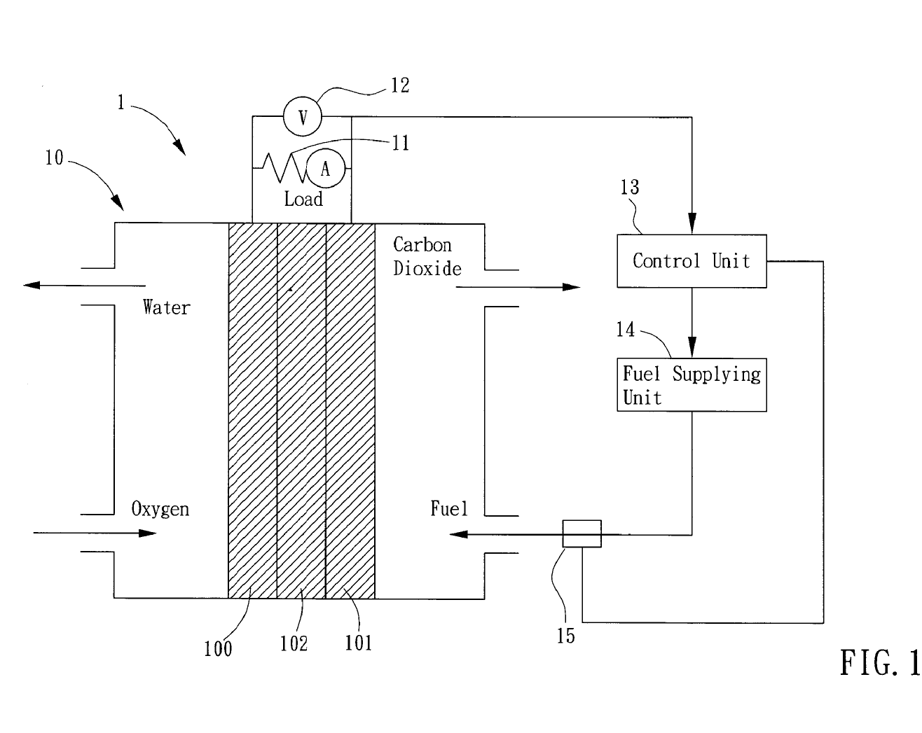

Please refer to FIG. 1, which is a schematic diagram of a fuel cell apparatus with a load according to a first embodiment of the present invention. The fuel cell apparatus 1 essentially comprises a fuel cell module 10, a fuel supplying unit 14, a fuel concentration sensor 15 and a measurement control unit 13.

The fuel cell module 10 comprises a pipeline for supplying methanol and air or oxygen and a pipeline for exhausting water and carbon dioxide. There are disposed a cathode plate 100, an anode plate 101 and a proton exchange membrane 102 disposed in the fuel cell apparatus 1 and a load 11 disposed between the anode plate 100 and the cathode plate 101 so that a loop is formed by the cathode plate 100, the anode plate 101 and the load 11. The load 11 is coupled to a meter 12. The meter 12 can be a voltmeter or an Ampere meter. In the present embodiment, the meter 12 is a voltmeter connected with the load in parallel. Alternatively, if the meter 12 is an Ampere meter, the load 11 is connected with the load in series.

The fuel cell apparatus 1 further comprises a fuel supplying unit 14, a fuel concentration sensor 15 and a measurement control unit 13. The fuel supplying unit 14 is coupled to the fuel cell module 10 to provide the fuel cell module 10 with fuel. The fuel concentration sensor 15 is coupled to the fuel cell module 10 to detect a fuel concentration in the fuel cell module 10 to generate a detection signal to be transmitted to the measurement control unit 13. In the present embodiment, the fuel concentration sensor 15 is a hydrogen-rich fuel concentration sensor. The hydrogen-rich fuel concentration sensor can be a methanol fuel concentration sensor, an ethanol fuel concentration sensor, a boron hydride fuel concentration sensor or a hydrogen fuel concentration sensor. Since the fuel cell uses a variety of types of fuels, the fuel concentration sensor is selected according to practical demands and is not limited to the aforesaid example. The measurement control unit 13 is coupled to the fuel cell module 10, the fuel supplying unit 14 and the fuel concentration sensor 15 to determine an operation concentration range of the fuel cell module 10 and to determine the timing for fuel injection according to the detection signal.

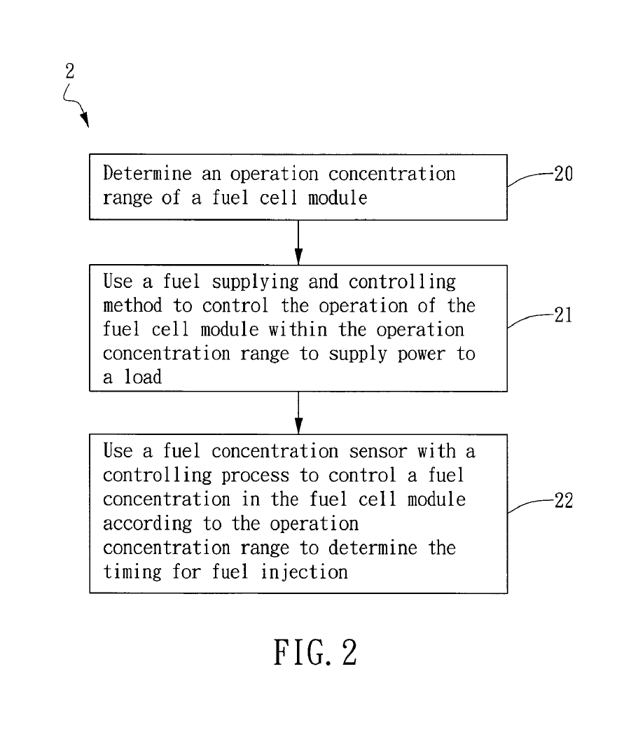

Please refer to FIG. 2, which is a flowchart of a fuel supplying and controlling method according to a first embodiment of the present invention. In the present embodiment, the fuel sensor-less control method is used as a main mechanism for the fuel cell to control the timing for fuel injection and as a second line of defense for monitoring the fuel concentration by monitoring whether the fuel concentration exceeds a pre-determined fuel concentration range using the fuel concentration sensor 15.

In order to describe the fuel supplying and controlling method of the present invention, the fuel cell apparatus in FIG. 1 is used to exemplify the method in FIG. 2. The fuel supplying and controlling method 2 in FIG. 2 comprises steps described hereinafter.

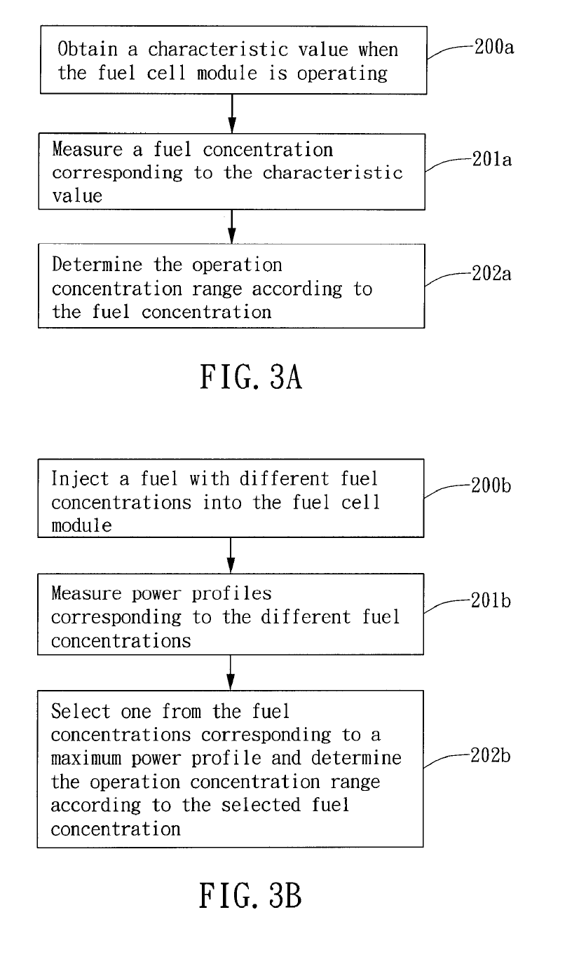

First, in Step 20, an operation concentration range of a fuel cell module 10 is determined corresponding to a load. Please refer to FIG. 3A, which is a flowchart of determining an operation concentration range according to a first embodiment of the present invention. In Step 200a, a characteristic value of the fuel cell module 10 when the fuel cell module 10 is operating corresponding to a load is obtained using a fuel sensor-less control method. The characteristic value is one of a maximum voltage, a maximum current, a maximum power and combination thereof measured during a time period of operation. Referring to FIG. 1, the characteristic value is the maximum voltage of a voltage distribution of the load 11 measured during a time period of operation by a voltmeter as the meter 12. Similarly, the characteristic value can be the maximum voltage or the maximum power, while detailed description thereof is not presented. The fuel sensor-less control method has been disclosed in Taiwan Patent Pub. No. 1274436, and thus detailed description thereof is not presented.

Referring to FIG. 3A, in Step 201a, a fuel concentration in the fuel cell module 10 corresponding to the characteristic value is measured by the fuel concentration sensor 15 after the characteristic value is determined. Then, in Step 202a, the operation concentration range is determined according to the measured fuel concentration by setting an upper limit and a lower limit based on the fuel concentration to obtain a fuel concentration range as the operation concentration range.

Please refer to FIG. 3B, which is a flowchart of determining an operation concentration range according to a second embodiment of the present invention. In the present embodiment, Step 200b is first performed to inject fuel with different fuel concentrations into the fuel cell module 10. Then, in Step 201b, the power profile for the fuel cell module 10 corresponding to each of the different fuel concentrations is measured. Finally, in Step 202b, one from the fuel concentrations is selected corresponding to a maximum power profile and the operation concentration range is determined according to the selected fuel concentration. In other words, an upper limit and a lower limit are set based on the fuel concentration to obtain a fuel concentration range as the operation concentration range.

Returning to FIG. 2, Step 21 is performed to use a fuel supplying and controlling method to control the operation of the fuel cell module 10 within the operation concentration range to supply power to a load after Step 20. Then in Step 22, a fuel concentration sensor 15 with a monitoring process is used to monitor a fuel concentration in the fuel cell module 10 according to the operation concentration range to determine the timing for fuel injection. In Step 21 in the present embodiment, only the fuel concentration sensor 15 of the fuel cell module 10 operates to determine whether the fuel concentration in the fuel cell module 10 is within the operation concentration range.

In the monitoring process, if the detected fuel concentration exceeds the upper limit of the operation concentration range, the measurement control unit 13 stops the fuel supplying unit 14 from supplying the fuel cell module 10 with fuel even though it is the time for fuel injection. Otherwise, if the detected fuel concentration is smaller than the lower limit of the operation concentration range, the measurement control unit 13 forces the fuel supplying unit 14 to supply the fuel cell module 10 with fuel to keep the operation of the fuel cell module 10. During the monitoring process, if the load changes due to being turned on/off for example so that the operation concentration range has be to re-determined as in Step 20, the measurement control unit 13 will perform Step 20. In other words, the operation concentration range will be re-determined when the load of the fuel cell module fluctuates. The operation concentration range can be re-determined using steps as described in FIG. 3A and FIG. 3B, which are not presented hereinafter. When the fuel concentration sensor is damaged or abnormal, Step 22 is performed. If the measurement control unit detects that the characteristic value is abnormal, for example, that the voltage, the power or the temperature is abnormal, a fuel sensor-less control method is used to control the operation of the fuel cell module 10 to provide power to the load 11. One object of Step 22 is to provide a second line of defense so that the fuel cell is kept operating normally.

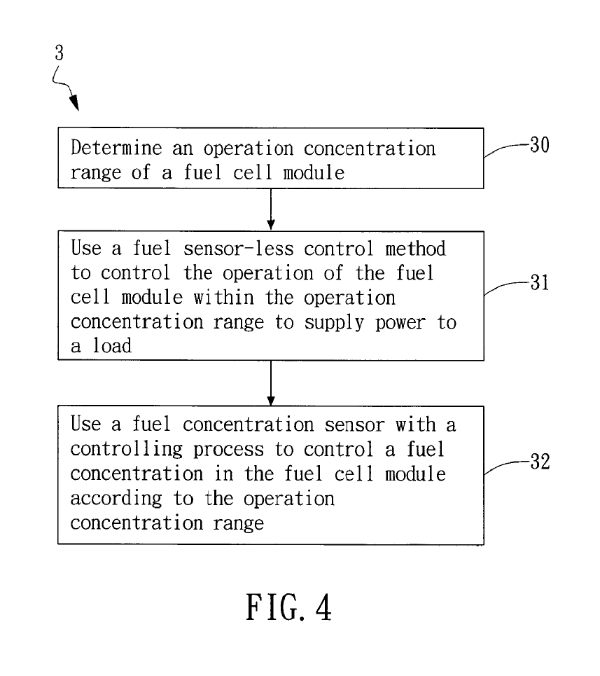

FIG. 4 is a flowchart of a fuel supplying and controlling method according to a second embodiment of the present invention. In the present embodiment, Step 30 is first performed to determine a operation concentration range of a fuel cell module 10. The operation concentration range is determined as in the embodiment in FIG. 3A and FIG. 3B. Then in Step 31, a fuel sensor-less control method is used to control the operation of the fuel cell module 10 within the operation concentration range to supply power to a load 11. The fuel supplying and controlling method in Step 31 is the fuel sensor-less control method. In other words, the fuel concentration in the fuel cell is monitored without using the fuel concentration sensor to control the timing for fuel injection. Similar methods are disclosed in Taiwan Patent Pub. No. 1274436, U.S. Pat. No. 6,698,278 and U.S. Pat. No. 6,991,865. However, the present invention is not limited thereto. In other words, the fuel supplying and controlling method in Step 31 can be any fuel sensor-less control method.

At last, in Step 32, a fuel concentration sensor 15 with a monitoring process is used to monitor a fuel concentration in the fuel cell module 10 according to the operation concentration range to determine the timing for fuel injection. One object of Step 32 is to improve the security of the fuel sensor-less control method in Step 31. With the use of the fuel concentration sensor 15, incorrect fuel injection can be avoided. Therefore, in Step 32, the monitoring process is used to monitor the fuel concentration in the fuel cell module 10 to keep the fuel cell operating normally.

In the present embodiment, the monitoring process in Step 32 is performed to monitor whether the fuel concentration in the fuel cell module exceeds the upper limit or is lower than the lower limit. In other words, when the fuel concentration exceeds the upper limit, the measurement control unit 13 stops the fuel supplying unit 14 from supplying the fuel cell module 10 with fuel according to the fuel concentration sensor 15 even though it is determined in the fuel supplying method in Step 21 that it is the time for fuel injection. Otherwise, when the fuel concentration is smaller than the lower limit, the measurement control unit 13 forces the fuel supplying unit 14 to supply the fuel cell module 10 with fuel according to the fuel concentration sensor 15 to keep the operation of the fuel cell module 10 even though it is determined in the fuel supplying method in Step 21 that fuel injection is not required.

According to the above discussion, it is apparent that the present invention discloses a fuel supplying and controlling method and a fuel cell apparatus using the fuel supplying and controlling method, in which a fuel sensor-less control method and a fuel concentration sensor are combined together to stabilize the operation of the fuel cell apparatus. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A fuel supplying and controlling method, comprising steps of:
determining an operation concentration range of a fuel cell module; and
using a fuel concentration sensor with a monitoring process to monitor a fuel concentration in the fuel cell module according to the operation concentration range to determine the timing for fuel injection.

2. The fuel supplying and controlling method as recited in claim 1, wherein the step of determining the operation concentration range of the fuel cell module further comprises steps of:
using a fuel sensor-less control method to obtain a characteristic value when the fuel cell module is operating;
measuring a fuel concentration corresponding to the characteristic value; and
determining the operation concentration range according to the fuel concentration.

3. The fuel supplying and controlling method as recited in claim 2, wherein the characteristic value is one of a maximum voltage, a maximum current, a maximum power and combination thereof measured during a time period of operation.

4. The fuel supplying and controlling method as recited in claim 1, wherein the step of determining the operation concentration range of the fuel cell module further comprises steps of:
injecting fuel with different fuel concentrations into the fuel cell module;
measuring power profiles corresponding to the different fuel concentrations; and
selecting one from the fuel concentrations corresponding to a maximum power profile and determining the operation concentration range according to the selected fuel concentration.

5. The fuel supplying and controlling method as recited in claim 1, wherein the monitoring process detects the fuel concentration in the fuel cell module using the fuel concentration sensor, and supplies the fuel to the fuel cell module if the fuel concentration is lower than the operation concentration range or stops supplying the fuel to the fuel cell module to function as a first line of defense if the fuel concentration is higher than the operation concentration range.

6. The fuel supplying and controlling method as recited in claim 1, further comprising steps of:
controlling the operation of the fuel cell module using a fuel sensor-less control method as a second line of defense to replace the abnormal or damaged fuel concentration sensor when the characteristic value for the fuel cell module is abnormal.

7. A fuel supplying and controlling method, comprising steps of:
determining an operation concentration range of a fuel cell module;
using a fuel sensor-less control method to control the operation of the fuel cell module within the operation concentration range to supply power to a load; and
using a fuel concentration sensor with a monitoring process to monitor a fuel concentration in the fuel cell module according to the operation concentration range to determine the timing for fuel injection.

8. The fuel supplying and controlling method as recited in claim 7, wherein the step of determining the operation concentration range of the fuel cell module further comprises steps of:
using a fuel sensor-less control method to obtain a characteristic value when the fuel cell module is operating;
measuring a fuel concentration corresponding to the characteristic value; and
determining the operation concentration range according to the fuel concentration.

9. The fuel supplying and controlling method as recited in claim 8, wherein the characteristic value is one of a maximum voltage, a maximum current, a maximum power and combination thereof measured during a time period of operation.

10. The fuel supplying and controlling method as recited in claim 7, wherein the step of determining the operation concentration range of the fuel cell module further comprises steps of:
injecting fuel of different fuel concentrations into the fuel cell module;
measuring power profiles corresponding to the different fuel concentrations; and
selecting one from the fuel concentrations corresponding to a maximum power profile and determining the operation concentration range according to the selected fuel concentration.

11. The fuel supplying and controlling method as recited in claim 7, wherein the monitoring process detects the fuel concentration in the fuel cell module using the fuel concentration sensor, and supplies the fuel to the fuel cell module if the fuel concentration is lower than the operation concentration range or stops supplying the fuel to the fuel cell module if the fuel concentration is higher than the operation concentration range.

12. The fuel supplying and controlling method as recited in claim 7, further comprising steps of:
re-determining the operation concentration range when the load of the fuel cell module varies.

13. A fuel cell apparatus, comprising:
a fuel cell module, being coupled to a load to provide the load with power required for operation;
a fuel supplying unit, being coupled to the fuel cell module to provide the fuel cell module with fuel;
a fuel concentration sensor, being coupled to the fuel cell module to detect a fuel concentration in the fuel cell module to generate a detection signal; and
a measurement control unit, being coupled to the fuel cell module, the fuel supplying unit and the fuel concentration sensor to determine an operation concentration range of the fuel cell module and to determine the timing for fuel injection according to the detection signal.

14. The fuel cell apparatus as recited in claim 13, wherein the fuel concentration sensor is a hydrogen-rich fuel concentration sensor.

15. The fuel cell apparatus as recited in claim 14, wherein the hydrogen-rich fuel concentration sensor is a methanol fuel concentration sensor, an ethanol fuel concentration sensor or a boron hydride fuel concentration sensor.

16. The fuel cell apparatus as recited in claim 14, wherein the hydrogen-rich fuel concentration sensor is a hydrogen fuel concentration sensor.
